(19) United States
(12) Patent Application Publication
(10) Pub. No.: US 2025/0081195 A1
(43) Pub. Date: Mar. 6, 2025

(54) REPETITION OF PHYSICAL DOWNLINK CONTROL CHANNEL

(71) Applicant: Nokia Technologies Oy, Espoo (FI)

(72) Inventors: Bo Bi, Hangzhou (CN); Alessio Marcone, Munich (DE); Frank Frederiksen, Aalborg (DK); Arman Ahmadzadeh, Munich (DE)

(21) Appl. No.: 18/798,257

(22) Filed: Aug. 8, 2024

(30) Foreign Application Priority Data
Aug. 29, 2023 (WO) PCT/CN2023/115611

(51) Int. Cl. H04W 72/1273; H04W 72/0446

(52) U.S. Cl. CPC H04W 72/1273; H04W 72/0446

(57) ABSTRACT

The present disclosure relates to a solution for repetition of physical downlink control channel (PDCCH). In particular, a first apparatus determines, within a frame in which a synchronization signal physical broadcast channel block (SS/PBCH block) is transmitted, a resource for at least one repetition of a PDCCH transmission based on a repetition factor configured for the PDCCH transmission and a multiplexing pattern associated with the SS/PBCH block and the PDCCH transmission. The first apparatus monitors, on the resource, the at least one repetition of the PDCCH transmission for obtaining control information from a second apparatus. In this way, it can reduce latency for the first apparatus and can also decrease a buffer size at the first apparatus

### FIELDS

Various example embodiments of the present disclosure generally relate to the field of telecommunication and in particular, to methods, devices, apparatuses and computer readable storage medium for repetition of physical downlink control channel (PDCCH).

### BACKGROUND

Coverage enhancement is a hot topic in communication field. For example, it may focus on an applicability of solutions developed by general new radio (NR) coverage enhancement to non-terrestrial network (NTN), and identifying potential issues and enhancements by considering the NTN characteristics including large propagation delay and satellite movement.

### SUMMARY

In a first aspect of the present disclosure, there is provided a first apparatus. The first apparatus comprises at least one processor; and at least one memory storing instructions that, when executed by the at least one processor, cause the first apparatus at least to: determine, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the

SS/PBCH block and the PDCCH transmission; and monitor, on the resource, the at least one repetition of the PDCCH transmission for obtaining control information from a second apparatus.

In a second aspect of the present disclosure, there is provided a second apparatus. The second apparatus comprises at least one processor; and at least one memory storing instructions that, when executed by the at least one processor, cause the second apparatus at least to: determine, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and transmit, to a first apparatus, the at least one repetition of the PDCCH transmission on the resource.

In a third aspect of the present disclosure, there is provided a method. The method comprises: determining, at a first apparatus, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and monitoring, on the resource, the at least one repetition of the PDCCH transmission for obtaining control information from a second apparatus.

In a fourth aspect of the present disclosure, there is provided a method. The method comprises: determining, at a second apparatus, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and transmitting, to a first apparatus, the at least one repetition of the PDCCH transmission on the resource.

In a fifth aspect of the present disclosure, there is provided a first apparatus. The first apparatus comprises means for determining, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and means for monitoring, on the resource, the at least one repetition of the PDCCH transmission for obtaining control information from a second apparatus.

In a sixth aspect of the present disclosure, there is provided a second apparatus. The second apparatus comprises means for determining, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and means for transmitting, to a first apparatus, the at least one repetition of the PDCCH transmission on the resource.

In a seventh aspect of the present disclosure, there is provided a computer readable medium. The computer readable medium comprises instructions stored thereon for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3A to FIG. 3C illustrate schematic diagrams of multiplexing patterns, respectively;

FIG. 3D illustrates SS/PBCH block transmission in various cases with different frequency band and sub-carrier spacing;

FIG. 4A and FIG. 4B illustrate schematic diagrams of PDCCH monitoring occasions associated with SS/PBCH block indices, respectively;

FIG. 4C illustrates a diagram of a structure of a slot in an SS/PBCH block frame;

FIG. 5A to FIG. 5F illustrate schematic diagrams of transmission resources for PDCCH repetitions according to some example embodiments of the present disclosure, respectively;

FIG. 6 illustrates another signaling chart for communication according to some example embodiments of the present disclosure;

FIG. 7 illustrates another schematic diagram of transmission resources for PDCCH repetitions according to some example embodiments of the present disclosure;

FIG. 8 illustrates a flowchart of a method implemented at a first apparatus according to some example embodiments of the present disclosure;

FIG. 9 illustrates a flowchart of a method implemented at a second apparatus according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), an Access Terminal (AT) or a very small aperture terminal (VSAT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “common search space (CSS)” may refer to a search space (i.e., a set of resources) that every UE needs to search for control signals for every UE or for a signaling message that is applied to every UE before dedicated channel is established for a specific UE. The term “control resource set (CORESET)” used herein may refer to a physical resource that is used to carry physical downlink control channel (PDCCH). The term “a repetition factor” used herein may refer to the number of repetitions of PDCCH. The term “bitmap” used herein may refer to a string including binary number. The term “monitoring occasion (MO)” used herein may refer to a set of resources that is used for control channel monitoring.

As mentioned above, coverage enhancement is one of the important aspects of communication system design. For example, the coverage performance of different uplink (UL) and downlink (DL) channels are assessed, and the bottleneck channels are identified. In NTN, when considering satellite power limitations due to, for example, regulatory requirements or power split among the beams of the satellite, the UL and DL channels related to initial access may need to be enhanced.

In some mechanisms, UL enhancements are proposed. For example, the UL enhancements on enhancements of the message 4 (Msg4) hybrid automatic repeat request-acknowledgement (HARQ-ACK) and enhancements to the demodulation reference signal (DMRS) bundling framework for physical uplink shared channel (PUSCH). It has been argued that the scope of the Msg4 HARQ-ACK should be expanded to also cover cases for physical uplink control channel (PUCCH) transmissions of HARQ-ACK when dedicated PUCCH resources have not been configured.

As discussed above, coverage enhancements have been studied. It has been discussed that some DL channels may need enhancements as well. For example, when considering satellite power limitations due to, for example, regulatory requirements or power split among the beams of the satellite, the channels related to initial access may need to be enhanced as well. In another example, when considering Power Flux Density (PFD) limits or more generically limits on satellite output power, coverage enhancements for the PDCCH channel may be needed.

In general, for improving coverage, there are three approaches that may be considered. These approaches are: (a) lowering the interference and noise contributions, (b) increasing the transmission power, and (c) increasing the received energy per bit through either reducing the payload or by transmitting over longer time. However, at least some of the approaches might not be feasible for NTN, e.g., due to satellite PFD limits. The approach (c) may be achieved by introducing repetitions of the channel to be enhanced. In the current 5G NR specifications, the repetition of UE specific search space (USS) PDCCH has been specified for the multi-transmission reception point (TRP) feature. The repetition feature, however, does not apply to the PDCCH in initial access and specifically to the Type0-PDCCH configured. Type0-PDCCH indicates the scheduling information for a physical downlink shared channel (PDSCH) transmission that carries the system information block 1 (SIB1) message.

For improving the physical layer performance of a channel, a larger number of resources may be assigned for transmission of the data or control channel. For example, the data and/or control channel may include a certain number of bits. One approach to achieve this is to repeat the transmission of the payload data multiple times to give the possibility to a receiver to combine the received signals and improve the reliability of the demodulated and decoded signals such as bits.

Based on this, to enhance the coverage of the Type0-PDCCH, a network device (e.g., gNB) may be configured to repeat the Type0-PDCCH multiple times in a same or different slot, and thereby allow a terminal device (e.g., UE) to combine the received Type0-PDCCH single transmissions. However, in order to be able to combine the multiple Type0-PDCCH repetitions, it is necessary for the UE to know at least if and how many repetitions are being transmitted by the gNB, and hence the time span of the Type0-PDCCH repetitions. It is not enough for the UE to decode the Type0-PDCCH with enhanced coverage.

At least to solve the above and/or other potential issues, example embodiments of the present disclosure provide a solution for PDCCH repetition. In particular, a first apparatus (such as a terminal device) determines within a frame in which a synchronization signal physical broadcast channel block (SS/PBCH block) is transmitted, a resource for at least one repetition of a PDCCH transmission based on a repetition factor configured for the PDCCH transmission and a multiplexing pattern associated with the SS/PBCH block and the PDCCH transmission. The first apparatus monitors, on the resource, the at least one repetition of the PDCCH transmission for obtaining control information from a second apparatus (such as a network device). In this manner, the latency for the first apparatus to decode a PDCCH transmission and subsequently start decoding a scheduled physical downlink shared channel (PDSCH) can be reduced. A buffer size at the first apparatus can be decreased. The coverage enhancement can thus be improved.

According to some example embodiments of the present disclosure, a second apparatus (such as a network device) determines within a frame in which a SS/PBCH block is transmitted, a resource for at least one repetition of a PDCCH transmission based on a repetition factor configured for the PDCCH transmission and a multiplexing pattern associated with the SS/PBCH block and the PDCCH transmission. The second apparatus transmits the at least one repetition of the PDCCH transmission on the resource to a first apparatus (such as a terminal device). In this manner, the coverage enhancement can be improved.

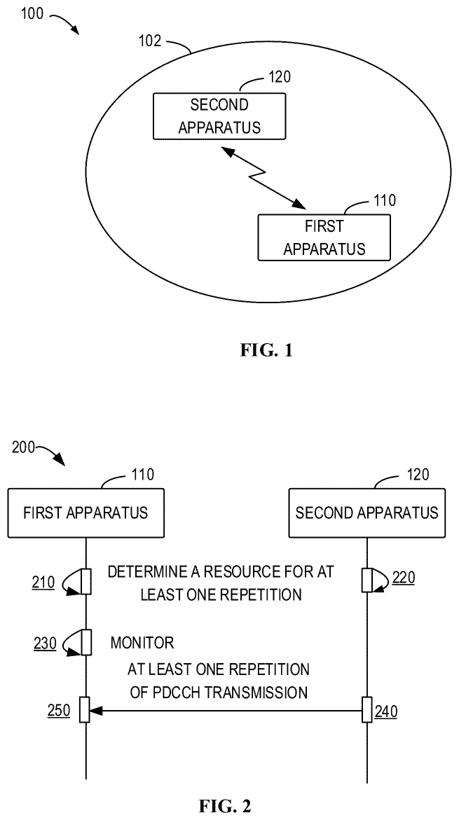

FIG. 1 illustrates an example communication environment 100 in which example embodiments of the present disclosure can be implemented. In the communication environment 100, a plurality of communication devices, including a first apparatus 110 and a second apparatus 120, can communicate with each other.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

The first apparatus 110 may be capable of receiving downlink control information (DCI) carried by Type0-PDCCH CCS set with repetitions. In some example embodiments, the first apparatus 110 may be a UE (e.g., an NTN UE) capable of Type0-PDCCH repetition, which may also be referred to as type 1 UE. The communication environment 100 may also include other terminal devices that are not capable of receiving DCI carried by Type0-PDCCH CCS set with repetitions, for example, a legacy UE or an NTN UE not capable of Type0-PDCCH reception with repetition, which can be referred to as type 2 UE.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings. Reference is now made to FIG. 2, which shows a signaling chart 200 for communication according to some example embodiments of the present disclosure. As shown in FIG. 2, the signaling chart 200 involves a first apparatus 110, and a second apparatus 120. For the purpose of discussion, reference is made to FIG. 1 to describe the signaling chart 200.

In operation, the first apparatus 110 determines (210) within a frame in which a SS/PBCH block is transmitted, a resource for at least one repetition of a PDCCH transmission based on a repetition factor configured for the PDCCH transmission and a multiplexing pattern associated with the SS/PBCH block and the PDCCH transmission. As used herein, the frame within which the SS/PBCH block is transmission can be referred to as “a frame for SS/PBCH transmission” or “a SS/PBCH block frame”. The frame may be associated with a system frame number (SFN). The first apparatus 110 monitors (230) on the resource, the at least one repetition of the PDCCH transmission for obtaining control information from the second apparatus 120. By way of example, the PDCCH transmission may be a Type0-PDCCH transmission.

In example embodiments of the present disclosure, the resource for the at least one repetition refers to a resource that is used for transmitting the repetition of the PDCCH transmission, which may also be referred to as a “repetition occasion” in some example embodiments. The term “repetition candidates” may refer to occasions (for example, one or more slots) that are available for transmitting the repetition of the PDCCH transmission. In some example embodiments, the resource, for example, the repetition occasion, may be determined based on the repetition candidates.

In some example embodiments, the resource determined at 210 for the at least one repetition may comprise one or more slots, and each of the slots does not overlap with a slot for an original transmission (also referred to as an initial transmission) of the PDCCH transmission. That is, the at least one repetition is transmitted in slot(s) which are non-overlapping with the slot for the original transmission of the PDCCH transmission.

As used herein, the repetition of PDCCH transmission in a slot different from the slot for the original transmission can be referred to as “inter-slot repetition of PDCCH transmission” or “time domain repetition of PDCCH transmission”. As the determined resource for the at least one repetition is within a frame containing the SS/PBCH transmission, the at least one repetition of the PDCCH transmission can be referred to as “inter-slot repetition within SS/PBCH block frame” or “inter-slot repetition within SS/PBCH block SFN of PDCCH transmission”. As used herein, the resource for the at least one repetition within the frame for SS/PBCH transmission can be referred to as “inter-slot repetition resource within the SS/PBCH frame”.

Based on the determined resource, the PDCCH common search space (CSS) set in the monitoring occasion slot in the SS/PBCH block SFN may be extended. Thus, the extended resource can also be referred to as “extended monitoring occasion” or “extended monitoring occasion slot” or “extended repetition slot” or “extended repetition occasion” or “monitoring occasion” or “monitoring occasion slot” or “repetition slot” or “repetition occasion”. By way of example, the Type0-PDCCH CSS can be extended for transmission of the at least one inter-slot repetition. The extended inter-slot repetition CSS may be linked to an original CSS. In example embodiments wherein the first apparatus 110 is a Type 1 UE, the first apparatus 110 can monitor (230) the repetitions on the extended CSS to improve Type0 PDCCH receiving performance. Alternatively, or in addition, if an apparatus is a Type 2 UE, the apparatus may monitor the original Type0 PDCCH CSS that is specified for example in release 18 (Rel-18) and ignore the linked extended CSS.

Likewise, the second apparatus 120 determines (220) within a single frame in which a SS/PBCH block is transmitted, a resource for at least one repetition of a PDCCH transmission based on a repetition factor configured for the PDCCH transmission and a multiplexing pattern associated with the SS/PBCH block and the PDCCH transmission. The second apparatus 120 transmits (240) the at least one repetition of the PDCCH transmission on the resource to the first apparatus 110. The first apparatus 110 may monitor (230) and receive (250) the at least one repetition of the PDCCH transmission on the resource.

In this manner, the repetition of the PDCCH transmission can be transmitted on the resource within a frame that contains the SS/PBCH block transmission. Such a frame is also referred to SS/PBCH block SFN for purpose of discussion. Such inter-slot repetition within SS/PBCH block SFN can reduce latency for the first apparatus 110 to successfully decode a PDCCH and subsequently start decoding a scheduled physical downlink shared channel (PDSCH) and thus decrease a buffer size of the first apparatus 110. By doing so, the coverage enhancements can be improved.

In some example embodiments, resources in the frame for the SS/PBCH block transmission are associated with SS/PBCH block indices. As used herein, the SS/PBCH block index may also be referred to as “an index for SS/PBCH block” or “an index”. The first apparatus 110 may determine the at least one SS/PBCH block index for the resource for the at least one repetition of the PDCCH transmission within the SS/PBCH block frame.

In some example embodiments, the repetition factor may be configured by the second apparatus 120 for the PDCCH transmission. By way of example, the configured repetition factor may be associated with one or more factors used for inter-slot repetition within the frame for SS/PBCH transmission. For instance, some of the factors may be determined according to the configured repetition factor. Related details will be described with the following example embodiments.

In some example embodiments, the multiplexing pattern associated with the SS/PBCH block and the PDCCH transmission may be configured by the second apparatus 120. The first apparatus 110 may obtain a control resource set (CORESET) and search space (refers to a time domain location for the PDCCH) for the PDCCH transmission. For example, the second apparatus 120 may transmit master information block (MIB) to the first apparatus 110. The first apparatus 110 may receive the MIB and determine the CORESET and search space for Type0-PDCCH based on MIB parameter(s) and at least one predefined table.

By way of example, if during cell search the first apparatus 110 determines from MIB that a CORESET for Type0-PDCCH CSS set is present, the first apparatus 110 determines a number of consecutive resource blocks and a number of consecutive symbols for the CORESET of the Type0-PDCCH CSS set from controlResourceSetZero in pdcch-ConfigSIB1, as described in Tables 13-1 through 13-10 in technical specification (TS) 38.213, for operation without shared spectrum channel access in frequency range 1 (FR1) and frequency range 2-1 (FR2-1), or as described in Tables 13-1A and 13-4A in TS 38.213 for operation with shared spectrum channel access in FR1, or as described in Table 13-10A in TS 38.213 for operation with shared spectrum channel access in FR2-2, and determine PDCCH monitoring occasions from searchSpaceZero in pdcch-ConfigSIB1, included in MIB, as described in Tables 13-11 through 13-15A in TS 38.213.

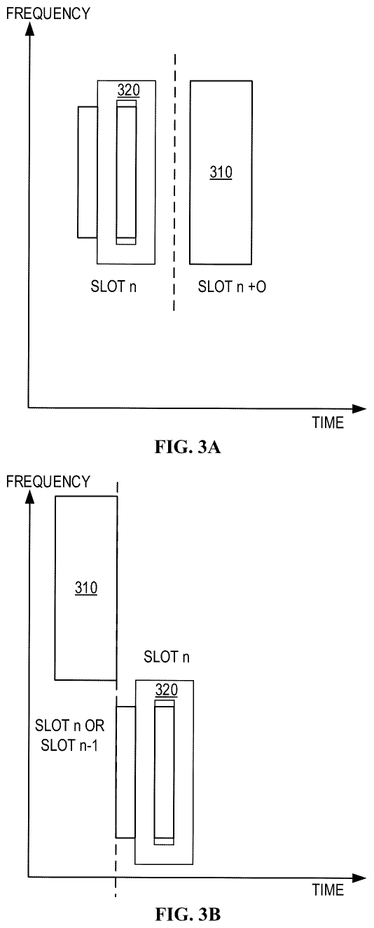

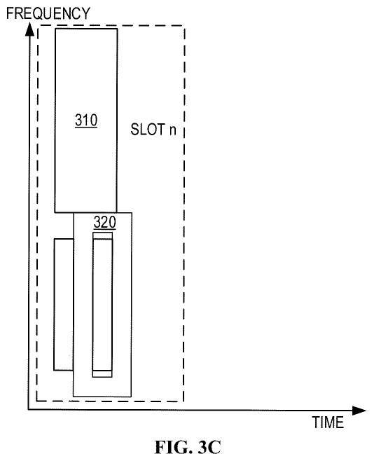

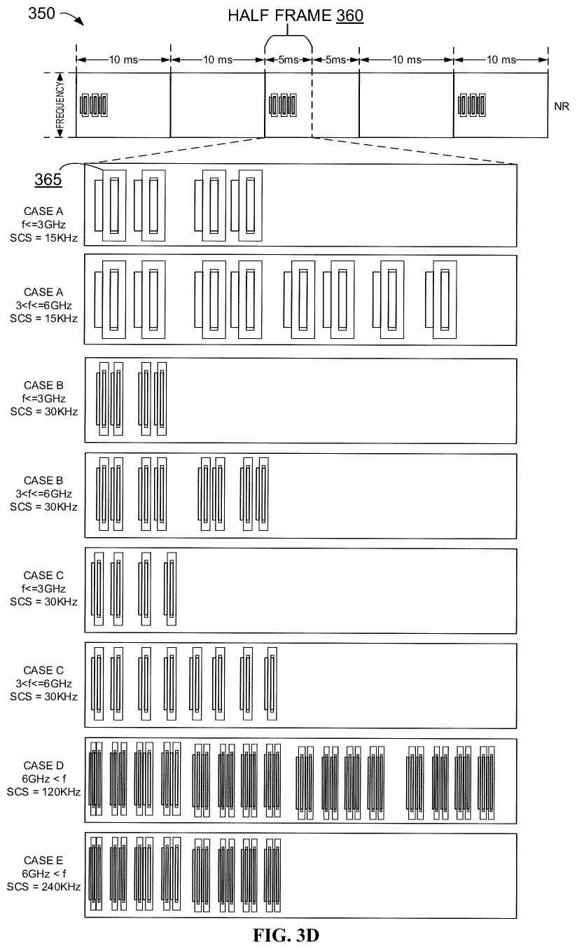

There may be various kinds of schemes or patterns for the SS/PBCH block (sometimes referred to as SSB) and CORESET0 multiplexing that is so-called multiplexing pattern, as shown in FIG. 3A to FIG. 3C. FIG. 3A shows a schematic diagram of a multiplexing pattern 1 for SS/PBCH block 320 and CORESET0 310. The multiplexing pattern 1 is also referred to as a first scheme for multiplexing the SS/PBCH block and CORESET. As shown in FIG. 3A, the SS/PBCH block 320 may be transmitted in slot n and the CORESET0 310 may be in slot n+O or subsequent slots, where n and O are integer numbers. Parameter O may be offset from the first slot, for example. The SS/PBCH block 320 and the CORESET0 310 may overlap in frequency domain.

FIG. 3B shows a schematic diagram of a multiplexing pattern 2 for a SS/PBCH block 320 and CORESET0 310. As shown in FIG. 3B, the SS/PBCH block 320 may be transmitted in slot n (where n is an integer number) and the CORESET0 310 may be in the same slot n or in a previous slot of slot n, i.e., in slot n−1. The SS/PBCH block 320 and the CORESET0 310 do not overlap in frequency domain in the example of FIG. 3B.

FIG. 3C shows a schematic diagram of a multiplexing pattern 3 for SS/PBCH block 320 and CORESET0 310. As shown in FIG. 3C, the SS/PBCH block 320 may be transmitted in slot n and the CORESET0 310 may be in slot n. The SS/PBCH block 320 and the CORESET0 310 may overlap in time domain. In some embodiments, for SS/PBCH block/CORESET0 multiplexing pattern 3, they may be in the same slot, and for multiplexing pattern 2, they may be either on the same slot or on two consecutive slots according to Tables 13-13 through 13-15A in TS 38.213. As used herein, the multiplexing pattern 2 may be referred to as a second scheme for multiplexing the SS/PBCH block and CORESET, and the multiplexing pattern 3 may be referred to as a third scheme for multiplexing the SS/PBCH block and CORESET.

In some example embodiments, the first apparatus 110 may assume that half frames with SS/PBCH blocks occur with a periodicity of two frames. In other words, the minimum periodicity of SS/PBCH block is two frames (for example, 20 ms), i.e., 2Nₛₗₒₜ^{frame,μ}, wherein Nₛₗₒₜ^{frame,μ} is specified by Table 1 (corresponding to Table 4.3.2-1 in TS 38.211) shown below. Specifically, Table 1 shows the number of OFDM symbols per slot, slots per frame, and slots per subframe for normal cyclic prefix.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In some example embodiments, for a half frame with SS/PBCH blocks, the first symbol indices for candidate SS/PBCH blocks may be determined according to the subcarrier spacing (SCS) μ of SS/PBCH blocks.

The first apparatus 110 may be provided per serving cell by ssb-periodicityServingCell a periodicity of the half frames for reception of the SS/PBCH blocks for the serving cell. If the first apparatus 110 is not configured a periodicity of the half frames for receptions of the SS/PBCH blocks, the first apparatus 110 may assume a periodicity of a half frame. The first apparatus 110 may assume that the periodicity is same for all SS/PBCH blocks in the serving cell. For initial cell selection, the first apparatus 110 may assume that half frames with SS/PBCH blocks occurs with a periodicity of two frames.

According to Table 2, which is based on Tables 13-1 through 13-10A in clause 13, TS 38.213, the supported SCS combination may be summarized as follows.

TABLE 2

| Multiplexing | | | | |
|---|---|---|---|---|
| Pattern | Support the combinations of [SCS of SSB, SC of PDCCH] | | | |
| 1 | [15, 15], | [120, 120], | [480, 480] | [960, 960] |
| | [15, 30], | [240, 60], | | |
| | [30, 15], | [240, 120] | | |
| | [30, 30], | | | |
| | [120, 60], | | | |
| 2 | [120, 60] | [240, 120] | | |
| 3 | | [120, 120] | [480, 480] | [960, 960] |

It is to be noted that, as examples, the multiplexing pattern 1 may be configured for all PDCCH SCS, the multiplexing pattern 2 may be configured for SCS of 60 and 120 kHz and the multiplexing pattern 3 may be configured for 120 kHz, 480 kHz and 960 kHz.

FIG. 3D illustrates SS/PBCH block transmission in various cases with different frequency band and sub-carrier spacing. The SS/PBCH block occasions shown in FIG. 3D may be configured according to clause 4.1 of TS 38.213. As illustrated, in FIG. 3D, NR SS/PBCH block is transmitted in various different patterns depending on subcarrier spacing and frequency range and some other parameters. In the illustrated example, in a half frame 360 of an SS/PBCH block frame, the SS/PBCH blocks are transmitted in different patterns for different cases. For example, for case A where the frequency range is less than or equal to 3 GHz and the subcarrier spacing is 15 kHz, a plurality of SS/PBCH blocks such as an SS/PBCH block 365 are transmitted within the half frame 360. There are some available slots such as spare slots in the half frame 360. For other cases, there are also some available slots as illustrated. It means that there are available slots for repetitions in half frame(s) wherein the first apparatus 110 may monitor (230) SS/PBCH and PDCCH transmission such as the Type0-PDCCH.

Still referring to FIG. 2, in some example embodiments, the first apparatus 110 may determine (210) the resource for the at least one repetition based on one or more available slots in a first half of the frame. The SS/PBCH block is contained in the first half of the frame. Likewise, the second apparatus 120 may determine (220) the resource for the at least one repetition based on one or more available slots in the first half of the frame. For purpose of illustration, several example embodiments for determining the resource for the at least one repetition will be described with respect to the first apparatus 110. It is to be understood that those example embodiments may also be implemented by the second apparatus 120.

Taking the multiplexing pattern being a first scheme (also referred to as multiplexing pattern 1) for multiplexing the SS/PBCH block and a CORESET for the PDCCH transmission as an example, the PDCCH monitoring occasion (n_0) may be determined by Tables 13-11 through 13-12A of TS 38.213. The following Table 3 is an example where number of slots in SFN is 20, O is offset from the first slot and M is multiplexing factor that denotes how many search space sets corresponding to SS/PBCH block indices are in a slot. The value in the table (in columns n_0) indicates which slot is the PDCCH occasion associated with the SSB index i. As shown in Table 3, there are available slots in the frame containing SS/PBCH block wherein PDCCH repetitions may be transmitted, e.g., in the row of index 0, the PDCCH occasion slots are slots 0-7 and the available slots are slots 8-19. The column on the left, “Index”, is a configuration index indicating different configuration profiles.

TABLE 3

| | | | n_0 | n_0 | n_0 | n_0 | n_0 | n_0 | n_0 | n_0 |
|---|---|---|---|---|---|---|---|---|---|---|
| Index | O | M | (i = 0) | (i = 1) | (i = 2) | (i = 3) | (i = 4) | (i = 5) | (i = 6) | (i = 7) |
| 0 | 0 | 1.0 | 0 | 1 | 2 | 3 | 4 | 5 | 6 | 7 |
| 1 | 0 | 0.5 | 0 | 0 | 1 | 1 | 2 | 2 | 3 | 3 |
| 2 | 2 | 1.0 | 4 | 5 | 6 | 7 | 8 | 9 | 10 | 11 |
| 3 | 2 | 0.5 | 4 | 4 | 5 | 5 | 6 | 6 | 7 | 7 |
| 4 | 5 | 1.0 | 10 | 11 | 12 | 13 | 14 | 15 | 16 | 17 |
| 5 | 5 | 0.5 | 10 | 10 | 11 | 11 | 12 | 12 | 13 | 13 |
| 6 | 7 | 1.0 | 14 | 15 | 16 | 17 | 18 | 19 | 0 | 1 |
| 7 | 7 | 0.5 | 14 | 14 | 15 | 15 | 16 | 16 | 17 | 17 |
| 8 | 0 | 2.0 | 0 | 2 | 4 | 6 | 8 | 10 | 12 | 14 |
| 9 | 5 | 2.0 | 10 | 12 | 14 | 16 | 18 | 0 | 2 | 4 |
| 10 | 0 | 1.0 | 0 | 1 | 2 | 3 | 4 | 5 | 6 | 7 |
| 11 | 0 | 1.0 | 0 | 1 | 2 | 3 | 4 | 5 | 6 | 7 |
| 12 | 2 | 1.0 | 4 | 5 | 6 | 7 | 8 | 9 | 10 | 11 |
| 13 | 2 | 1.0 | 4 | 5 | 6 | 7 | 8 | 9 | 10 | 11 |
| 14 | 5 | 1.0 | 10 | 11 | 12 | 13 | 14 | 15 | 16 | 17 |
| 15 | 5 | 1.0 | 10 | 11 | 12 | 13 | 14 | 15 | 16 | 17 |

In some example embodiments, for the first scheme for multiplexing the SS/PBCH block and CORESET for the PDCCH transmission, the first apparatus 110 may determine (210) the resource for the at least one repetition of the PDCCH transmission in the available slots based on a first parameter associated with subcarrier spacing of the CORESET, a total number of slots in the frame, a maximum number of SS/PBCH blocks indices in a cell, an offset from the first slot in the frame and a multiplexing factor indicating the number of search space sets corresponding SS/PBCH blocks indices in a slot. The total number of slots in the frame may be determined based on the first parameter associated with subcarrier spacing of the CORESET.

By way of example, the first apparatus 110 may determine (210) the resource based on the following equation (1):

$${n}_{0 , j}^{frame} = ( O \cdot {2}^{μ} + ⌊ ( i + j \cdot {L}_{max} ) \cdot M ⌋ ) / {N}_{slot}^{frame , μ} \qquad ( 1 )$$

where n_{0,j}^{frame} represents a slot used for the jth repetition in the at least one repetition, j∈{0, 1, . . . , K−1}, j=0 indicates the original transmission slot and j >0 indicates the repetition slots, K represents a repetition factor used for inter-slot repetition within the frame (also referred to as a second factor), μ represents the first parameter, i represents an SS/PBCH block index, Lₘₐₓ represents the maximum number of SS/PBCH blocks indices in a cell, Nₛₗₒₜ^{frame,μ} represents the total number of slots in the frame, O represents the offset from the first slot in the frame, and M represents the multiplexing factor.

The determined n_{0,j}^{frame} may refer to a slot index for the at least one repetition in the SS/PBCH block frame. K may denote the Type0-PDCCH monitoring occasions in the SS/PBCH block SFN. The repetition slots may be extended based on original monitoring occasions which are specified as configuration in Tables 13-11 through 13-12A of TS 38.213. In some example embodiments, the first parameter may be μ∈{1,2,3,4,5,6}, O and M may be from at least one predefined table, the maximum number of SS/PBCH blocks indices Lₘₐₓ may be specified in clause 4.1 of TS 38.213. For example, the value of these parameters may be specified in Table 1 shown above.

Several examples of the determined resources for the at least one repetition is shown in Table 4 below. These resources in Table 4 are determined by using equation (1) described above.

TABLE 4

| N | 20 | | original transmission occasion (j = 0) | | | | | | | | | repetition occasion slot (j = 1) | | | | | | | | |
|---|---|---|---|---|---|---|---|---|---|---|---|---|---|---|---|---|---|---|---|---|
| SS/PBCH block index | | | 0 | 1 | 2 | 3 | 4 | 5 | 6 | 7 | | 0 | 1 | 2 | 3 | 4 | 5 | 6 | 7 | |
| Index | O | M | n_0 (i = 0~7, j = 0) | | | | | | | | j | n_0 (i = 0~7, j = 1) | | | | | | | | j |
| 0 | 0 | 1.0 | 0 | 1 | 2 | 3 | 4 | 5 | 6 | 7 | 0 | 8 | 9 | 10 | 11 | 12 | 13 | 14 | 15 | 1 |
| 1 | 0 | 0.5 | 0 | 0 | 1 | 1 | 2 | 2 | 3 | 3 | 0 | 4 | 4 | 5 | 5 | 6 | 6 | 7 | 7 | 1 |
| 2 | 2 | 1.0 | 4 | 5 | 6 | 7 | 8 | 9 | 10 | 11 | 0 | 12 | 13 | 14 | 15 | 16 | 17 | 18 | 19 | 1 |
| 3 | 2 | 0.5 | 4 | 4 | 5 | 5 | 6 | 6 | 7 | 7 | 0 | 8 | 8 | 9 | 9 | 10 | 10 | 11 | 11 | 1 |
| 4 | 5 | 1.0 | 10 | 11 | 12 | 13 | 14 | 15 | 16 | 17 | 0 | 18 | 19 | 0 | 1 | 2 | 3 | 4 | 5 | 1 |
| 5 | 5 | 0.5 | 10 | 10 | 11 | 11 | 12 | 12 | 13 | 13 | 0 | 14 | 14 | 15 | 15 | 16 | 16 | 17 | 17 | 1 |
| 6 | 7 | 1.0 | 14 | 15 | 16 | 17 | 18 | 19 | 0 | 1 | 0 | 2 | 3 | 4 | 5 | 6 | 7 | 8 | 9 | 1 |
| 7 | 7 | 0.5 | 14 | 14 | 15 | 15 | 16 | 16 | 17 | 17 | 0 | 18 | 18 | 19 | 19 | 0 | 0 | 1 | 1 | 1 |
| 8 | 0 | 2.0 | 0 | 2 | 4 | 6 | 8 | 10 | 12 | 14 | 0 | 16 | 18 | 0 | 2 | 4 | 6 | 8 | 10 | 1 |
| 9 | 5 | 2.0 | 10 | 12 | 14 | 16 | 18 | 0 | 2 | 4 | 0 | 6 | 8 | 10 | 12 | 14 | 16 | 18 | 0 | 1 |
| 10 | 0 | 1.0 | 0 | 1 | 2 | 3 | 4 | 5 | 6 | 7 | 0 | 8 | 9 | 10 | 11 | 12 | 13 | 14 | 15 | 1 |
| 11 | 0 | 1.0 | 0 | 1 | 2 | 3 | 4 | 5 | 6 | 7 | 0 | 8 | 9 | 10 | 11 | 12 | 13 | 14 | 15 | 1 |
| 12 | 2 | 1.0 | 4 | 5 | 6 | 7 | 8 | 9 | 10 | 11 | 0 | 12 | 13 | 14 | 15 | 16 | 17 | 18 | 19 | 1 |
| 13 | 2 | 1.0 | 4 | 5 | 6 | 7 | 8 | 9 | 10 | 11 | 0 | 12 | 13 | 14 | 15 | 16 | 17 | 18 | 19 | 1 |
| 14 | 5 | 1.0 | 10 | 11 | 12 | 13 | 14 | 15 | 16 | 17 | 0 | 18 | 19 | 0 | 1 | 2 | 3 | 4 | 5 | 1 |
| 15 | 5 | 1.0 | 10 | 11 | 12 | 13 | 14 | 15 | 16 | 17 | 0 | 18 | 19 | 0 | 1 | 2 | 3 | 4 | 5 | 1 |

In the example of Table 4, it is assumed that the number of slots in a frame is 20, the maximum number of SS/PBCH block indices is 8. For the configuration index 0, the original transmission slots are in {0, 1, . . . , 7}, and the repetition occasions are in {8, 9, . . . , 15}. There is no collision.

In this manner, the PDCCH repetition(s) may be transmitted (240) after the PDCCH associated SS/PBCH blocks indices. The available slots in the half frame that contains SS/PBCH block can be exploited for the PDCCH repetitions. The PDSCH conveyed system information block 1 (SIB1) symbols are not touched and they may be kept as the same as in the schemes without PDCCH repetition.

In some example embodiments, one of the available slots that overlaps with a slot for an original PDCCH transmission associated with an index of a SS/PBCH block (also referred to an SS/PBCH block index) is discarded from slots to be used for the at least one repetition of the PDCCH transmission. That is, the extending slot for repetitions that is overlapping with original occasion slot may be skipped for repetitions, which means the slot for repetition candidate is invalid. As shown in Table 4, for the configuration index 8, the occasions for original transmission and the occasions for repetition of the transmission are overlapping. Hence, the repetition occasions may be skipped due to invalidity.

Alternatively, or in addition, in some example embodiments, if a slot, which is used for one of the at least one repetition of the PDCCH transmission associated with an SS/PBCH block index of the SS/PBCH block, overlaps with a slot for an original transmission of the PDCCH transmission, one of the at least one repetition of the PDCCH transmissions associated with all SS/PBCH block indices is skipped. For example, once the extending slot for repetitions that is overlapping with original occasion slot is skipped, the inter-slot repetition factor may fall back to a previous value, e.g., K=K−1, to avoid the resource collision.

Several example embodiments regarding determining the resource for the at least one repetition in the frame for SS/PBCH transmission for multiplexing pattern 1 have been described. In some example embodiments, if the multiplexing pattern is a second scheme (such as the multiplexing pattern 2 or multiplexing pattern 3) for multiplexing the SS/PBCH block and a CORESET for the PDCCH transmission, there are available slots for the repetition of the PDCCH transmission. For the second scheme, the possible PDCCH SCS may be 60 kHz, 120 KHz, 480 KHz and 960 kHz. The corresponding Nₛₗₒₜ^{frame,μ} may be 40, 80, 320 and 640.

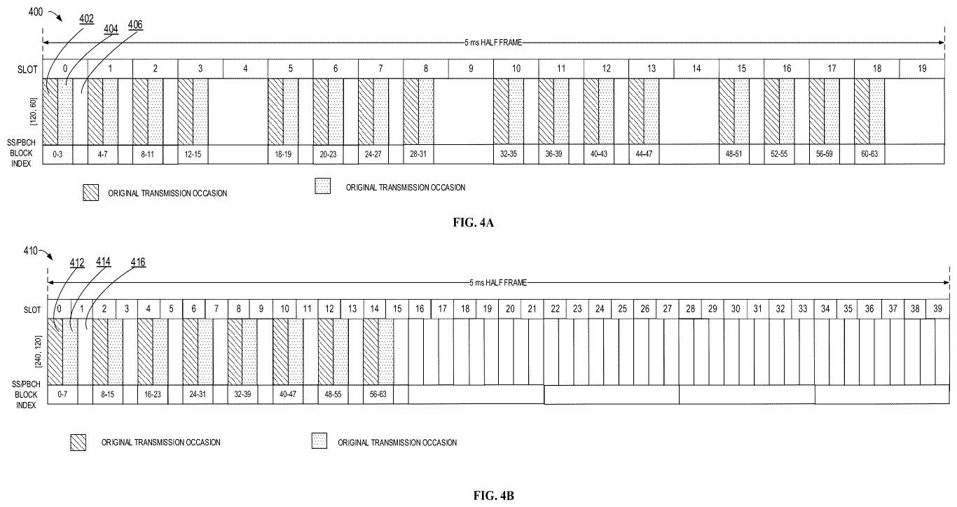

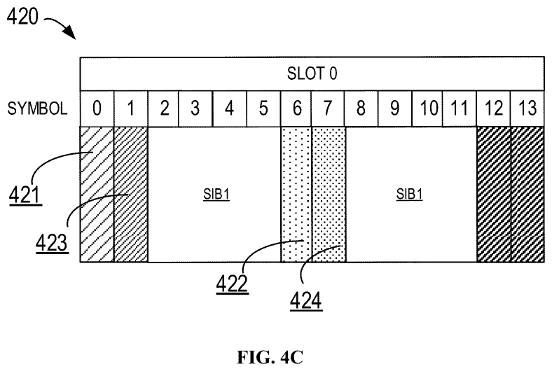

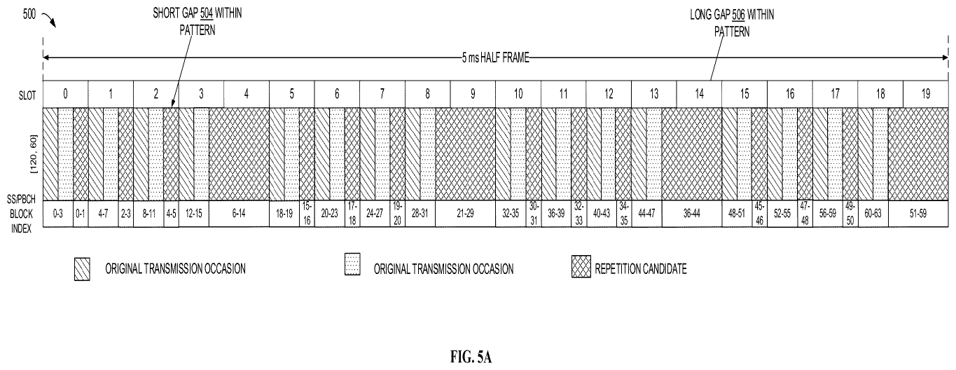

For SS/PBCH block/CORESET0 multiplexing pattern 3, they are in the same slot, and for multiplexing pattern 2, they can be either on the same slot or on two consecutive slots according to Tables 13-13 through 13-15A of TS 38.213. FIG. 4A shows a diagram 400 of PDCCH monitoring occasions in case where subcarrier spacing (SCS) of PDCCH is 60 KHz. As illustrated, there are a plurality of original transmission occasions such as an original transmission occasion 402 and an original transmission occasion 404 in a half frame for the SS/PBCH block transmission. The half frame may also include several available transmission occasions for the PDCCH repetition (also referred to as repetition occasion or repetition candidate), such as a repetition candidate 406.

FIG. 4B shows a diagram 410 of PDCCH monitoring occasions in case where subcarrier spacing (SCS) of PDCCH is 120 Khz. Similar to FIG. 4A, there are a plurality of original transmission occasions such as an original transmission occasion 412 and an original transmission occasion 414 in a half frame for the SS/PBCH block transmission. The half frame may also include several available transmission occasions for the PDCCH repetition (also referred to as repetition occasion or repetition candidate), such as a repetition candidate 416.

It is to be understood that a transmission occasion or a repetition occasion illustrated in FIG. 4A and FIG. 4B and the following figures may represent one or more transmission occasions or repetition occasions. For example, the original transmission occasion 402 in FIG. 4A may represent two transmission occasions associated with SS/PBCH indices 0 and 1. The original transmission occasion 404 may represent two transmission occasions associated with SS/PBCH indices 2 and 3. For another example, the original transmission occasion 412 in FIG. 4B may represent two transmission occasions associated with SS/PBCH indices 0 to 3. The original transmission occasion 414 may represent two transmission occasions associated with SS/PBCH indices 4 to 7.

It is to be understood that in the following illustrated example embodiments, the indices for the PDCCH transmission may be similar to those described with respect to FIG. 4A and FIG. 4B, which will not be repeated hereinafter.

FIG. 4C illustrates a diagram 420 of a structure of a slot (slot 0) in an SS/PBCH block frame. As illustrated, a symbol 421 and a symbol 423 may be used for an original transmission occasion associated with 2 SS/PBCH block indices such as SS/PBCH block index 0 and index 1, a symbol 422 and a symbol 424 may be used for an original transmission occasion associated with other 2 SS/PBCH block indices such as SS/PBCH block index 2 and index 3. For example, the symbol 421 and the symbol 423 may be used for the original transmission occasion 402 in FIG. 4A, and the symbol 422 and the symbol 424 may be used for the original transmission occasion 404 in FIG. 4A.

As illustrated in FIG. 4A and FIG. 4B, there are available slots among the PDCCH monitoring occasions and in the tail of half a frame wherein the repetitions may be transmitted. The available slots, e.g., slot 406 and slot 416, may be referred to as repetitions candidates.

Still refers to FIG. 2, in some example embodiments, if the multiplexing pattern is a second scheme for multiplexing the SS/PBCH block and a control resource set for the PDCCH transmission, the first apparatus 110 may determine whether the available slots in the first half of the frame are enough for the whole PDCCH transmission associated with all SS/PBCH blocks. If the available slots in the first half of the frame are not enough for the whole PDCCH transmission associated with all SS/PBCH blocks, the first apparatus 110 may determine that a part of the SS/PBCH blocks is transmitted with the at least one repetition in the frame and the other part of the SS/PBCH blocks is discarded.

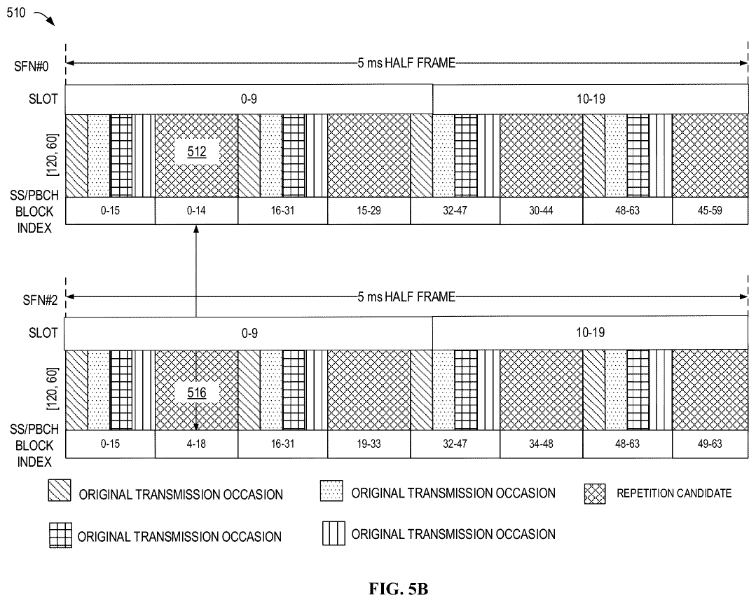

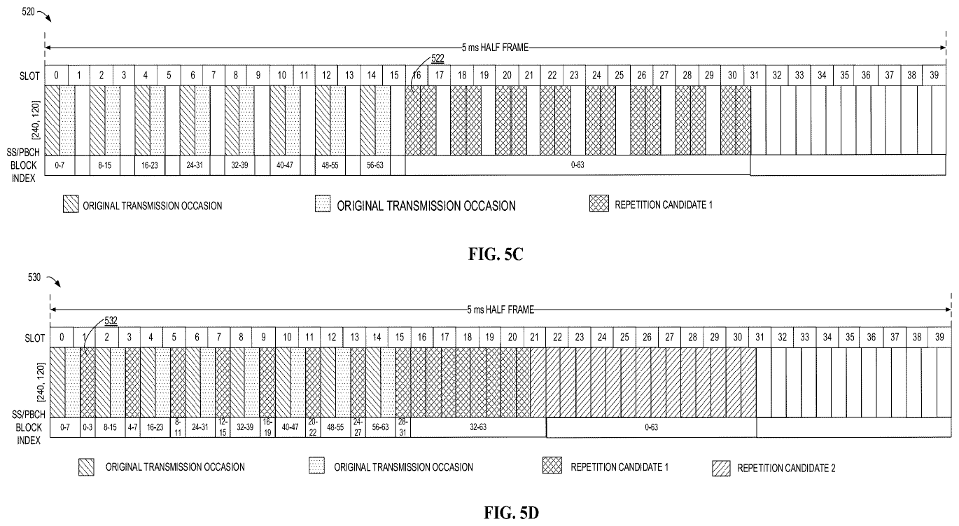

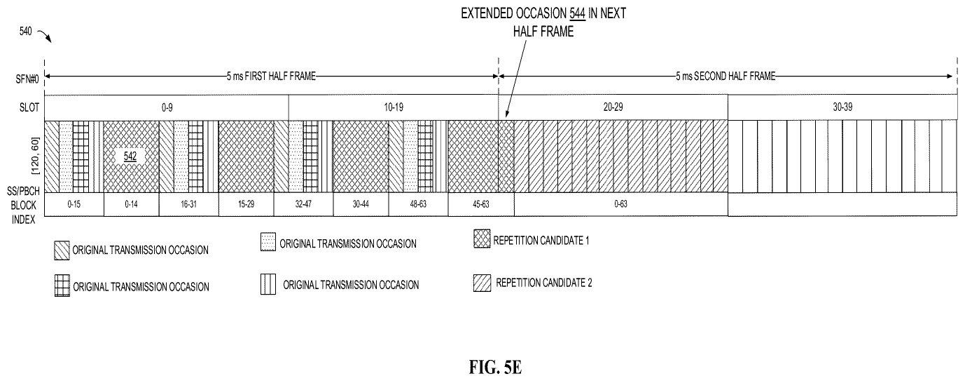

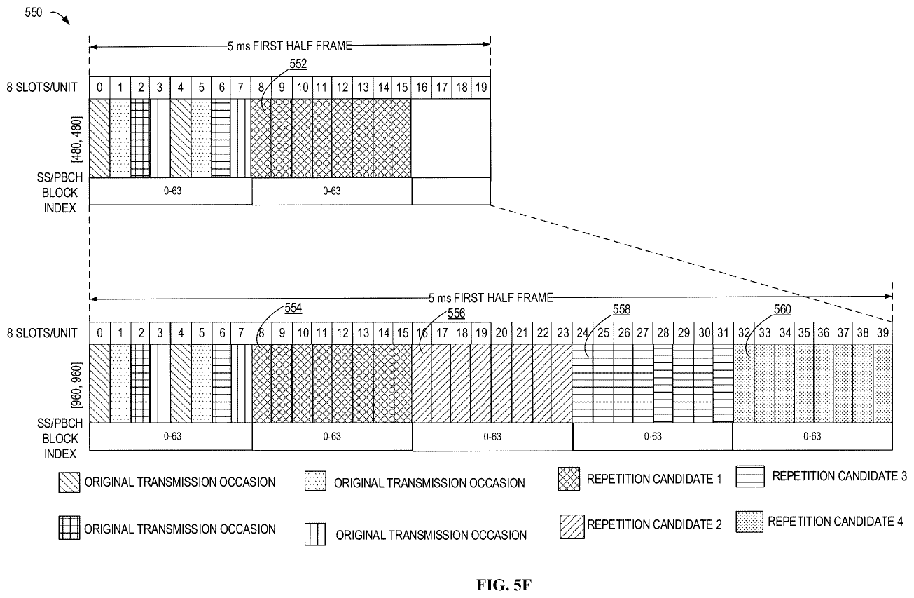

By way of example, when the available slots to be extended for repetitions are not enough for the whole Type0-PDCCH associated with all SS/PBCH block indices (e.g., 64), the partial Type0-PDCCH associated SS/PBCH blocks (60/64) may be transmitted with repetitions. The repetitions for the rest of Type0-PDCCH are discarded. A schematic diagram 500 of such transmission resources for PDCCH repetitions is illustrated in FIG. 5A. As illustrated, PDCCH repetitions are limited in the half frame of SS/PBCH block. The advantage is saving resource and processing capacity that is fitting to current specification. A short gap 504 within pattern and a long gap 506 within pattern may be involved, as shown in FIG. 5A.

Referring back to FIG. 2, alternatively, or in addition, in some example embodiments, if the available slots in the first half of the frame are not enough for the whole PDCCH transmission associated with all SS/PBCH blocks, the first apparatus 110 may determine that a first part of the SS/PBCH blocks is transmitted with the at least one repetition in the frame and a second part of the SS/PBCH blocks is transmitted with the at least one repetition in a further frame. By way of example, the first part of the SS/PBCH blocks and the second part of the SS/PBCH blocks are transmitted in a round robin way.

A schematic diagram 510 of such transmission resources for PDCCH repetitions is illustrated in FIG. 5B. As illustrated, the first part may comprise a first number of PDCCH occasions, for example, 60 PDCCH occasions corresponding to SSB indices from 0 to 59. The second part may comprise a second number of PDCCH occasions, for example, 60 PDCCH occasions corresponding to SSB indices from 4 to 63. As illustrated, the first part may include a repetition occasion 512 corresponding to SSB indices from 0 to 14, and the second part may include a repetition occasion 516 corresponding to SSB indices 4 to 18.

It is to be noted that the above examples of the first number of PDCCH occasions and/or the second number of PDCCH occasions are just discussed for illustration. In other example embodiments, the first number and/or the second number may have other values, which may be either more than or less than 60, and the first number is not necessarily equal to the second number.

In some example embodiments, the available slots to be extended are not enough for repetitions of the whole Type0-PDCCH associated with all SS/PBCH block indices, a partial Type0-PDCCH may be transmitted with repetitions, and the rest Type0-PDCCH associated with one or more SS/PBCH block indices may be transmitted with repetitions in at least one next SS/PBCH block frame. The Type0-PDCCH associated with all SS/PBCH block indices may be transmitted in a round robin way.

As illustrated in FIG. 5B, the discarding repetitions are assigned to different groups of PDCCH associated with SS/PBCH block indices in a round robin way. With this method, repetition occasions are fairly assigned to different PDCCH associated with SS/PBCH block index.

Referring back to FIG. 2, in some example embodiments, if the multiplexing pattern is the second scheme and the first apparatus 110 determines that the available slots in the first half of the frame are enough for the whole PDCCH transmission associated with all SS/PBCH blocks, the first apparatus 110 may determine, from the available slots, extending slots which are used for the at least one repetition. The extending slots correspond to a repetition pattern which is the same as an original pattern corresponding to an occasion for an original transmission of the PDCCH transmission.

By way of example, if the available slots to be extended are enough for repetitions of the whole Type0-PDCCH associated with all SS/PBCH block indices, the extending slots may be the occasions with the same pattern as the original occasion. In other words, the repetition occasions are filled with the same sequence in the original occasion and distributed in next pluralities of available occasions. The number of repetitions is determined by available slots.

A schematic diagram 520 of such transmission resources for PDCCH repetitions is illustrated in FIG. 5C. As illustrated, the repetition occasions such as the repetition occasion 522 are copied from original occasion pattern and distributed in next pluralities of occasions. With this method, the benefit is that the transmission occasion for repetitions determination is similar with original PDCCH occasion and then decrease the implementation complexity of the first and second apparatus.

Referring back to FIG. 2, alternatively, or in addition, in some example embodiments, if the first apparatus 110 determines that the available slots in the first half of the frame are enough for the whole PDCCH transmission associated with all SS/PBCH block indices, the first apparatus 110 may determine, from the available slots, extending slots which are used for the at least one repetition, wherein the extending slots correspond to a repetition pattern which is different from an original pattern corresponding to an occasion for an original transmission of the PDCCH transmission.

By way of example, if the available slots to be extended are enough for repetitions of the whole Type0-PDCCH associated with all SS/PBCH block indices, the extending slots may be the occasions with a different pattern as compared to original occasion because there are still some available slots within the original occasion pattern (the gap slot). Due to utilizing the gap slot, the repetition pattern is not the same as original pattern. With this method, the available slots are fully utilized thereby decreasing the transmission latency. The number of repetitions is determined by available slots.

A schematic diagram 530 of such transmission resources for PDCCH repetitions is illustrated in FIG. 5D. As illustrated, the gap slots such as a repetition occasion 532 are utilized for repetitions. Therefore, the inter-slot repetition factor is 3.

Referring back to FIG. 2, in some example embodiments, if the multiplexing pattern is the second scheme, the first apparatus 110 may determine (210) the resource for the at least one repetition based on one or more available slots in a first half of the frame and/or in a second half of the frame. The SS/PBCH block is contained in the first half of the frame and/or in the second half of the frame.

By way of example, the available slots in the first half or/and second half frame containing SS/PBCH block are proposed to be extended for repetitions. This may be useful, for example, in a case, wherein the PDCCH SCS is 60 KHz, and the number of slots in a half frame is 20 and the number of available slots for repetition is not enough.

A schematic diagram 540 of such transmission resources for PDCCH repetitions is shown in FIG. 5E. As illustrated, there are 60 repetition occasions such as repetition occasion 542 while original maximum number of transmission occasion corresponding SS/PBCH block index is 64. Compared with FIG. 5A in which there are 4 Type0-PDCCH associated SS/PBCH block index lack of repetition occasion, the second half frame in FIG. 5E can be extended for repetition. For example, an extended occasion 544 in the next half frame may be used for PDCCH repetition.

Referring back to FIG. 2, in some example embodiments, the at least one time domain repetition in a half frame which contains SS/PBCH block may be transmitted by using the available slots in the first half frame. For example, with the multiplexing pattern 3, PDCCH SCS being 480 kHa or 960 kHz, the available slots in the first half frame containing SS/PBCH block are proposed to be extended for repetitions. Due to no gap slots among original occasions, the pattern of extending occasions for repetitions is the same as original occasions. If the available occasion permits, the available occasion may be allocated for the pluralities of repetitions within the half frame. A schematic diagram 550 of such transmission resources for PDCCH repetitions is shown in FIG. 5F. As illustrated, there are no available gap occasions in PDCCH transmission pattern, the available occasions such as a repetition occasion 552 within the half frame are extended for repetitions for the case where PDCCH SCS is 480 kHz. For the case wherein PDCCH SCS is 960 kHz, the available occasions such as repetition occasions 554, 556, 558 and 560 within the half frame are extended for repetitions. Inter-slot repetition factor is determined by the number of available resources.

Reference is now made back to FIG. 2. As mentioned, the resource for the at least one repetition may be determined (210/220) based on the repetition factor. In an example, the repetition factor may be associated with a first factor used for intra-slot repetition. As used herein, the term “intra-slot repetition” may refer to a repetition of the PDCCH transmission using a different OFDM symbol level time or frequency resource in a same slot for the original transmission of the PDCCH transmission. The term “intra-slot repetition” may also be referred to as “OFDM symbol level time or frequency domain repetition”.

In another example, the repetition factor may be associated with a second factor used for inter-slot repetition within the frame. In a further example, the repetition factor may be associated with a third factor used for inter-slot repetition across frames. As used herein, the term “inter-slot repetition across frames” may refer to a repetition of the PDCCH transmission in a time domain resource such as a slot in another frame than the SS/PBCH block frame.

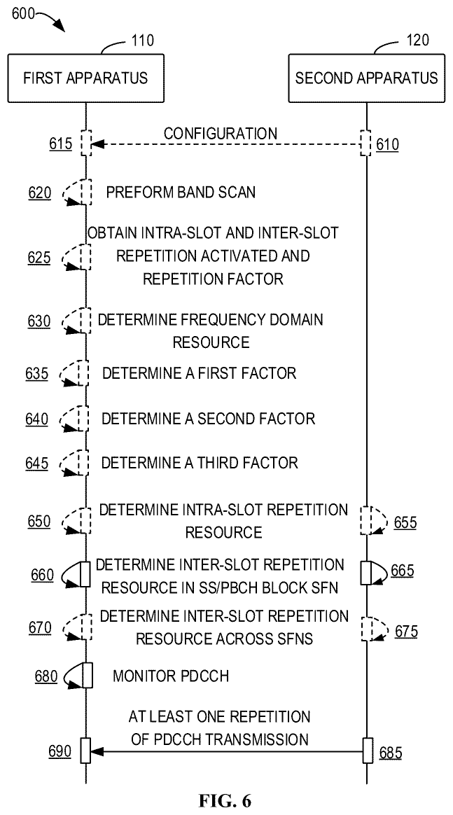

The first factor and the second factor may be determined based on the available resource(s). For example, the first factor may be determined based on available frequency resource within a slot. For another example, the second factor may be determined based on available resources such as available slots within an SSB frames. The third factor may be determined based on the first and second factor. Details regarding the determination of the second factor and the third factor will be described with respect to FIG. 6.

The second factor may be determined based on available time domain resources within the SS/PBCH block frame. For example, the second factor may be determined based on the determined resource for the at least one inter-slot repetition within the SS/PBCH block frame.

In some example embodiments, the first apparatus 110 and/or the second apparatus 120 may determine the second factor based on the configured repetition factor and the first factor. In some example embodiments, the repetition factor may denote the total number of PDCCH transmission including the original transmission and the repetitions. By way of example, the repetition factor may be a configured repetition factor (denoted as K_{c}) such as 8 or any other suitable value. The first factor (denoted as K₁) and the second factor (denoted as K₂) may denote the number of inter-slot repetitions and the number of inter-slot repetitions within the SS/PBCH block frame, respectively.

In some example embodiments, a priority of the first factor is higher than a priority of the second factor, and the priority of the second factor is higher than a priority of the third factor. For example, different levels may be prioritized for intra-slot repetition (L1), inter-slot repetition within SS/PBCH block frame (L2) and inter-slot repetition cross SFNs (L3), e.g., first priority is intra-slot repetition, second priority is inter-slot repetition within SS/PBCH block frame and 3^{rd} priority is inter-slot repetition cross SFNs according to impact to transmission latency. Different repetition types for a configured repetition factor may be applied based on corresponding priorities in descending order. For example, the first factor may be applied first, then the second factor, and at last the third factor. That is, the intra-slot repetition may be applied first, then the inter-slot repetition within a single frame, and at last the inter-slot repetition across different frames.

The first factor K₁ may be determined based on available resource(s). K₂ may be determined based on K_{c} and K₁. For example, if the first factor (K₁) is 2, and the repetition factor K_{c} is 8, then the second factor (K₂) may be determined as follows:

$${K}_{2} = Min ( {K}_{2 max} , ⌈ \frac{{K}_{c}}{{K}_{1}} ⌉ ) = Min ( 2 , \frac{8}{2} ) = 2 \qquad ( 2 )$$

where K₂ₘₐₓ represents the maximum number of inter-slot repetitions in a frame, which may be determined based available slots in the frame. In the above example, K₂ₘₐₓ=2 for instance.

It is to be understood that the example values for these factors are only for the purpose of illustration, without suggesting any limitation. These factors may have other suitable values in further example embodiments of the present disclosure.

Alternatively, or in addition, in some example embodiments, the first apparatus 110 and/or the second apparatus 120 may determine the third factor based on the repetition factor, the first factor and the second factor.

In example embodiments where the repetition factor (K_{c}) denotes the total number of PDCCH transmission including the original transmission and the repetitions, the first factor (K₁), the second factor (K₂) and the third factor K₃ may denote the number of inter-slot repetitions, the number of inter-slot repetitions within the SS/PBCH block frame, and the number of inter-slot repetitions across frames, respectively. K₁ and K₂ may be determined based on available resource(s). K₃ may be determined based on K., K₁ and K₂. For example, if the first factor (K₁) is 4, the repetition factor K₃ is 8, and the second factor (K₂) is 2, then the third factor (K₃) may be determined as follows:

$${K}_{3} = ⌈ \frac{{K}_{c}}{{K}_{1} + {K}_{2}} ⌉ = ⌈ \frac{8}{4 + 2} ⌉ = 2. \qquad ( 3 )$$

It is to be understood that the example values for these factors are only for the purpose of illustration, without suggesting any limitation. These factors may have other suitable values in further example embodiments of the present disclosure.

Example embodiments regarding determining (210/220) the resource for the at least one repetition in the SS/PBCH block frame have been described. With these embodiments, the first apparatus 110 and the second apparatus 120 can autonomously determine Type0-PDCCH inter-slot repetition resource within SS/PBCH block frame via extending available slot occasions. The inter-slot repetition within the SS/PBCH block SFN can reduce latency for the first apparatus 110 to successfully decode a PDCCH and subsequently start decoding the scheduled PDSCH. The buffer size in the first apparatus 110 can thus be reduced. In this manner, the coverage enhancements can be improved.

As mentioned, the repetition factor may be associated with a first factor for intra-slot repetition and a third factor for inter-slot repetition across frames. In some example embodiments, the present inter-slot repetition within the SS/PBCH block frame may be in combination with the intra-slot repetition and/or the inter-slot repetition.

FIG. 6 illustrates another signaling chart 600 for communication according to some example embodiments of the present disclosure. As shown in FIG. 6, the signaling chart 600 involves a first apparatus 110, and a second apparatus 120. For the purpose of discussion, reference is made to FIG. 1 to describe the signaling chart 600. In the signaling chart 600, the inter-slot repetition within the SS/PBCH block frame, the intra-slot repetition and the inter-slot repetition across frames may be combined.

As illustrated, the second apparatus 120 may transmit (610) a configuration to the first apparatus 110. The first apparatus 110 may receive (215) the configuration. The configuration may include the repetition factor, the CORESET0 and CSS via some parameters in MIB. In other words, the second apparatus 120 may configure the repetition factor, CORESET0 and CSS. The first apparatus 110 may obtain the MIB and obtain the configured repetition factor, CORESET0 and CSS.

It is to be understood that the configuration of the repetition factor and the configuration of the CORESET) and CSS may be transmitted (610) in a single MIB or in two different MIBs. Scope of the present disclosure is not limited in this regard.

The first apparatus 110 may perform (620) a band scan and get a synchronization with the second apparatus 120, e.g., frequency and frame synchronization. The first apparatus 110 which is Type 1 UE may obtain (625) that the intra-slot and inter-slot repetition activated for the first apparatus 110, the repetition factor is 8 (K_{c}=8). Other apparatuses that are Type 2 UEs may understand there is no CORESET0 associated SS/PBCH blocks and there is CORESET0 associated second SS/PBCH block. The first apparatus 110 may determine (630) frequency domain resources via ControlResourceSetZero and SearchSpaceZero.

In some example embodiments, the first apparatus 110 may determine (635) a first factor used for the intra-slot repetition, such as K₁. For example, the first apparatus 110 may determine (635) the first factor based on available transmission resource(s) for a set of intra-slot repetitions of the PDCCH transmission. In an example, the available transmission resource(s) for the set of intra-slot repetitions may be determined based on the number of symbols per slot, the number of symbols related to a search space set of the PDCCH, and the number of search space sets per slot. In another example, the available transmission resource(s) for the set of intra-slot repetitions may be determined based on the number of symbols per slot, the number of symbols related to a search space set of the PDCCH, the number of search space sets per slot, and a number of symbols to be reserved for transmission of a scheduled PDSCH. In a further example, the available transmission resource(s) for the set of intra-slot repetitions may be determined based on the number of symbols per slot, the number of symbols related to a search space set of the PDCCH, the number of search space sets, the number of symbols to be reserved, and an index of a synchronization signal physical broadcast channel block.

In some example embodiments, the first apparatus 110 may determine (640) the second factor (K₂) for the inter-slot repetition within the SS/PBCH block frame. The determination of the second factor may be similar to that described with respect to FIG. 2 to FIG. 5F, which will not be repeated here.

In some example embodiments, the first apparatus 110 may determine (645) the third factor for the inter-slot repetition across frames, such as K₃. For example, the third factor may be determined (645) by using

$${K}_{3} = ⌈ \frac{{K}_{c}}{{K}_{1} + {K}_{2}} ⌉ .$$

Assuming that the first factor is determined (635) as 2, the second factor is determined (640) as 2, then the third factor may be determined (645) to be

$${K}_{3} = ⌈ \frac{{K}_{c}}{{K}_{1} + {K}_{2}} ⌉ = ⌈ \frac{8}{2 + 2} ⌉ = 2 .$$

It is to be understood that in some example embodiments, the second apparatus 120 may determine the first factor, the second factor and the third factor in a similar way.

In some example embodiments, the first apparatus 110 may determine (650) the intra-slot repetition resource, for example based on the first factor. The second apparatus 120 may determine (655) the intra-slot repetition resource, as well.

The first apparatus 110 determines (660) the inter-slot repetition resource in the SS/PBCH block SFN. The second apparatus 120 determines (665) the inter-slot repetition resource in the SS/PBCH block SFN in a similar way. Details regarding determination of the inter-slot repetition resource in the SS/PBCH block SFN have been described with respect to FIG. 2 to FIG. 5F, which will not be repeated here.

In some example embodiments, the first apparatus 110 may determine (670) the inter-slot repetition resource across frames such as SFNs, for example based on the third factor. The second apparatus 120 may determine (675) the inter-slot repetition resource across frames, as well.

Based on these determined resources, the first apparatus 110 may determine a starting symbol index and offset of respective search space sets in a slot and repetition occasions within SS/PBCH block frame, repetition occasions cross SFN (SFN_{c}, n₀).

The first apparatus 110 monitors (680) the repetition of the PDCCH transmission such as the Type0-PDCCH repetitions corresponding to the number of system frame (SFN_{c})/the number of slot (Slot_{c})/start symbol index/symbols number.

The second apparatus 120 may transmit (685) the at least one repetition of PDCCH transmission to the first apparatus 110 based on these determined (655/665/675) resources. The first apparatus 110 may receive (690) the at least one repetition. The at least one repetition may include a combination of intra-slot repetition, inter-slot repetition within SS/PBCH block frame and inter-slot repetition across frames. The first apparatus 110 may perform the reception of Type0-PDCCH and corresponding SIB1.

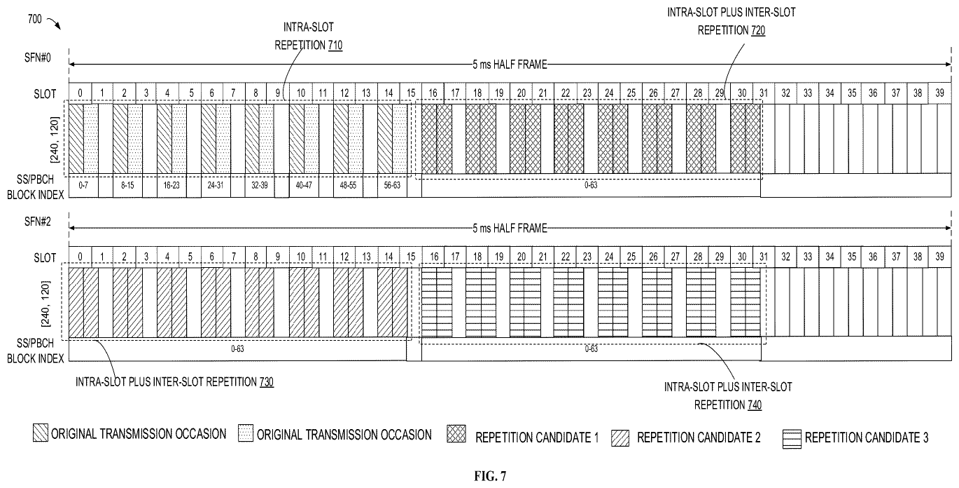

A diagram 700 of the corresponding repetition occasions may be depicted as shown in FIG. 7. As illustrated, in SFN #0, in a beginning half of the half frame for SS/PBCH block transmission with SS/PBCH block indices 0-7, 8-15, 16-23, 24-31, 32-39, 40-47, 48-55 and 56-63, an intra-slot repetition 710 may be transmitted. In the SFN #0, in a remaining part of the half frame with SS/PBCH block indices 0-63, a combined repetition 720 such as the intra-slot repetition combined with inter-slot repetition within the SS/PBCH block frame may be transmitted by using the shaded slots.

Likewise, in the SFN #2 with SS/PBCH block indices 0-7, 8-15, 16-23, 24-31, 32-39, 40-47, 48-55 and 56-63, a combined repetition 730 or a combine repetition 740 such as the intra-slot repetition combined with inter-slot repetition across frames may be transmitted.

By using such combined repetition of the PDCCH repetition, it can reduce latency for the first apparatus 110 to successfully decode a PDCCH and subsequently start decoding the scheduled PDSCH. The buffer size in the first apparatus 110 can thus be reduced. In this manner, the coverage enhancements can be improved.

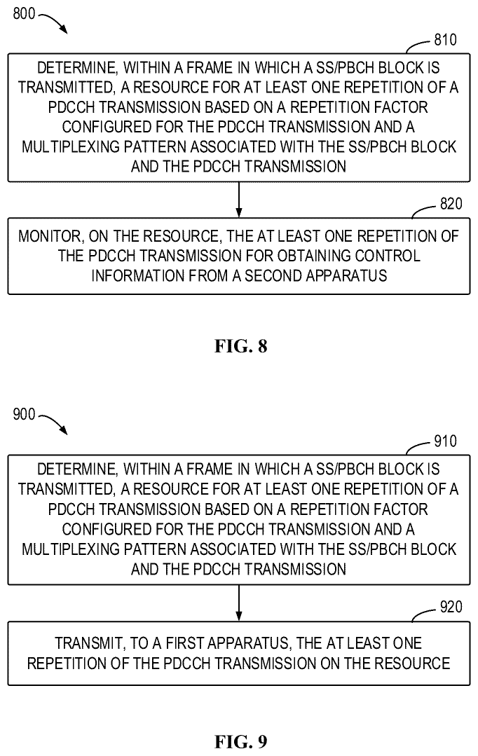

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus 110 determines, within a frame in which a SS/PBCH block is transmitted, a resource for at least one repetition of a PDCCH transmission based on a repetition factor configured for the PDCCH transmission and a multiplexing pattern associated with the SS/PBCH block and the PDCCH transmission.

At block 820, the first apparatus 110 monitors, on the resource, the at least one repetition of the PDCCH transmission for obtaining control information from a second apparatus.

In some example embodiments, the method 800 further comprises: determining the resource for the at least one repetition based on one or more available slots in a first half of the frame, wherein the SS/PBCH block is contained in the first half of the frame.

In some example embodiments, the method 800 further comprises: determining the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

In some example embodiments, the method 800 further comprises: determining the resource based on the following: n_{0,j}^{frame}=(0·2^{μ}+└(i+j·Lₘₐₓ)·M┘)/Nₛₗₒₜ^{frame,μ}, where n_{0,j}^{frame} frame represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH block indices in a cell, Nₛₗₒₜ^{frame,μ} represents the total number of slots in the frame, O represents the offset from the first slot in the frame, and M represents the multiplexing factor.

In some example embodiments, one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

In some example embodiments, if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

In some example embodiments, the method 800 further comprises: in accordance with a determination that the available slots in the first half of the frame are not enough for whole of the PDCCH transmission associated with all SS/PBCH blocks, determining that a part of the SS/PBCH blocks is transmitted with the at least one repetition in the frame and the other part of the SS/PBCH blocks is discarded; or in accordance with a determination that the available slots in the first half of the frame are not enough for whole of the PDCCH transmission associated with all SS/PBCH blocks, determining that a first part of the SS/PBCH blocks is transmitted with the at least one repetition in the frame and a second part of the SS/PBCH blocks is transmitted with the at least one repetition in a further frame.

In some example embodiments, the first part of the SS/PBCH blocks and the second part of the SS/PBCH blocks are transmitted in a round robin way.

In some example embodiments, the method 800 further comprises: in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is the same as an original pattern corresponding to an occasion for an original transmission of the PDCCH transmission; or in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is different from an original pattern corresponding to an occasion for an original transmission of the PDCCH transmission.

In some example embodiments, the method 800 further comprises: determining the resource for the at least one repetition based on one or more available slots in a first half of the frame and/or in a second half of the frame, wherein the SS/PBCH block is contained in the first half of the frame and/or in the second half of the frame.

In some example embodiments, the repetition factor is associated with at least one of the following: a first factor used for intra-slot repetition, a second factor used for inter-slot repetition within the frame, or a third factor used for inter-slot repetition across frames.

In some example embodiments, the method 800 further comprises: determining the second factor based on the repetition factor and the first factor; or determining the third factor based on the repetition factor, the first factor and the second factor.

In some example embodiments, a priority of the first factor is higher than a priority of the second factor, and the priority of the second factor is higher than a priority of the third factor.

In some example embodiments, the first apparatus comprises a terminal device, and the second apparatus comprises a network device.

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus 120 determines, within a frame in which a SS/PBCH block is transmitted, a resource for at least one repetition of a PDCCH transmission based on a repetition factor configured for the PDCCH transmission and a multiplexing pattern associated with the SS/PBCH block and the PDCCH transmission.

At block 920, the second apparatus 120 transmits, to a first apparatus, the at least one repetition of the PDCCH transmission on the resource.

In some example embodiments, the method 900 further comprises: determining the resource for the at least one repetition based on one or more available slots in a first half of the frame, wherein the SS/PBCH block is contained in the first half of the frame.

In some example embodiments, the method 900 further comprises: determining the resource for the at least one repetition of the PDCCH transmission in the one or more available slots based on a first parameter associated with subcarrier spacing (u) of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

In some example embodiments, the method 900 further comprises: determining the resource based on the following: n_{0,j}^{frame}=(O·2^{μ}+└(i+j·Lₘₐₓ)·M┘)/Nₛₗₒₜ^{frame,μ}, where n_{0,j}^{frame} the represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH block indices in a cell, Nₛₗₒₜ^{frame,μ} represents the total number of slots in the frame, O represents the offset from the first slot in the frame, and M represents the multiplexing factor.

In some example embodiments, one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

In some example embodiments, if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

In some example embodiments, the method 900 further comprises: in accordance with a determination that the available slots in the first half of the frame are not enough for whole of the PDCCH transmission associated with all SS/PBCH blocks, determining that a part of the SS/PBCH blocks is transmitted with the at least one repetition in the frame and the other part of the SS/PBCH block is discarded; or in accordance with a determination that the available slots in the first half of the frame are not enough for whole of the PDCCH transmission associated with all SS/PBCH blocks, determining that a first part of the SS/PBCH blocks is transmitted with the at least one repetition in the frame and a second part of the SS/PBCH blocks are transmitted with the at least one repetition in a further frame.

In some example embodiments, the first part of the SS/PBCH blocks and the second part of the SS/PBCH blocks are transmitted in a round robin way.

In some example embodiments, the method 900 further comprises: in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is the same as an original pattern corresponding to an occasion for an original transmission of the PDCCH transmission; or in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is different from an original pattern corresponding to an occasion for an original transmission of the PDCCH transmission.

In some example embodiments, the method 900 further comprises: determining the resource for the at least one repetition based on one or more available slots in a first half of the frame and/or in a second half of the frame, wherein the SS/PBCH block is contained in the first half of the frame and/or in the second half of the frame.

In some example embodiments, the repetition factor is associated with at least one of the following: a first factor used for intra-slot repetition, a second factor used for inter-slot repetition within the frame, or a third factor used for inter-slot repetition across frames.

In some example embodiments, the method 900 further comprises: determining the second factor based on the repetition factor and the first factor; or determining the third factor based on the repetition factor, the first factor and the second factor.

In some example embodiments, a priority of the first factor is higher than a priority of the second factor, and the priority of the second factor is higher than a priority of the third factor.

In some example embodiments, the first apparatus comprises a terminal device, and the second apparatus comprises a network device.

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for determining, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and means for monitoring, on the resource, the at least one repetition of the PDCCH transmission for obtaining control information from a second apparatus.

In some example embodiments, the first apparatus further comprises: means for determining the resource for the at least one repetition based on one or more available slots in a first half of the frame, wherein the SS/PBCH block is contained in the first half of the frame.

In some example embodiments, the multiplexing pattern is a first scheme for multiplexing the SS/PBCH block and a control resource set for the PDCCH transmission, the first apparatus further comprises: means for determining the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

In some example embodiments, the first apparatus further comprises: means for determining the resource based on the following: n_{0,j}^{frame}=(O·2^{μ}+└(i+j·Lₘₐₓ)·M┘)/Nₛₗₒₜ^{frame,μ}, where n_{0,j}^{frame} represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH block indices in a cell, Nₛₗₒₜ^{frame,μ} represents the total number of slots in the frame, O represents the offset from the first slot in the frame, and M represents the multiplexing factor.

In some example embodiments, one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

In some example embodiments, if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

In some example embodiments, the multiplexing pattern is a second scheme for multiplexing the SS/PBCH block and a control resource set for the PDCCH transmission, the first apparatus further comprises: means for in accordance with a determination that the available slots in the first half of the frame are not enough for whole of the PDCCH transmission associated with all SS/PBCH blocks, determining that a part of the SS/PBCH blocks is transmitted with the at least one repetition in the frame and the other part of the SS/PBCH blocks is discarded; or means for in accordance with a determination that the available slots in the first half of the frame are not enough for whole of the PDCCH transmission associated with all SS/PBCH blocks, determining that a first part of the SS/PBCH blocks is transmitted with the at least one repetition in the frame and a second part of the SS/PBCH blocks is transmitted with the at least one repetition in a further frame.

In some example embodiments, the first part of the SS/PBCH blocks and the second part of the SS/PBCH blocks are transmitted in a round robin way.

In some example embodiments, the multiplexing pattern is a second scheme or a third scheme for multiplexing the SS/PBCH block and a control resource set for the PDCCH transmission, the first apparatus further comprises: means for in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is the same as an original pattern corresponding to an occasion for an original transmission of the PDCCH transmission; or means for in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is different from an original pattern corresponding to an occasion for an original transmission of the PDCCH transmission.

In some example embodiments, the multiplexing pattern is a second scheme for multiplexing the SS/PBCH block and a control resource set, the first apparatus further comprises: means for determining the resource for the at least one repetition based on one or more available slots in a first half of the frame and/or in a second half of the frame, wherein the SS/PBCH block is contained in the first half of the frame and/or in the second half of the frame.

In some example embodiments, the repetition factor is associated with at least one of the following: a first factor used for intra-slot repetition, a second factor used for inter-slot repetition within the frame, or a third factor used for inter-slot repetition across frames.

In some example embodiments, the first apparatus further comprises: means for determining the second factor based on the repetition factor and the first factor; or means for determining the third factor based on the repetition factor, the first factor and the second factor.

In some example embodiments, a priority of the first factor is higher than a priority of the second factor, and the priority of the second factor is higher than a priority of the third factor.

In some example embodiments, the first apparatus further comprises means for performing other operations in some example embodiments of the method 800 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for determining, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and means for transmitting, to a first apparatus, the at least one repetition of the PDCCH transmission on the resource.

In some example embodiments, the second apparatus further comprises: means for determining the resource for the at least one repetition based on one or more available slots in a first half of the frame, wherein the SS/PBCH block is contained in the first half of the frame.

In some example embodiments, the multiplexing pattern is a first scheme for multiplexing the SS/PBCH block and a control resource set for the PDCCH transmission, the second apparatus further comprises: means for determining the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

In some example embodiments, the second apparatus further comprises: means for determining the resource based on the following: n_{0,j}^{frame}=(O·2^{μ}+└(i+j·Lₘₐₓ)·M┘)/Nₛₗₒₜ^{frame,μ}, where n_{0,j}^{frame} represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH block indices in a cell, Nₛₗₒₜ^{frame,μ} represents the total number of slots in the frame, O represents the offset from the first slot in the frame, and M represents the multiplexing factor.

In some example embodiments, one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

In some example embodiments, if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

In some example embodiments, the multiplexing pattern is a second scheme for multiplexing the SS/PBCH block and a control resource set for the PDCCH transmission, the second apparatus further comprises: means for in accordance with a determination that the available slots in the first half of the frame are not enough for whole of the PDCCH transmission associated with all SS/PBCH blocks, determining that a part of the SS/PBCH blocks is transmitted with the at least one repetition in the frame and the other part of the SS/PBCH block is discarded; or means for in accordance with a determination that the available slots in the first half of the frame are not enough for whole of the PDCCH transmission associated with all SS/PBCH blocks, determining that a first part of the SS/PBCH blocks is transmitted with the at least one repetition in the frame and a second part of the SS/PBCH blocks are transmitted with the at least one repetition in a further frame.

In some example embodiments, the first part of the SS/PBCH blocks and the second part of the SS/PBCH blocks are transmitted in a round robin way.

In some example embodiments, the multiplexing pattern is a second scheme or a third scheme for multiplexing the SS/PBCH block and a control resource set for the PDCCH transmission, the second apparatus further comprises: means for in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is the same as an original pattern corresponding to an occasion for an original transmission of the PDCCH transmission; or means for in accordance with a determination that the available slots in the first half of the frame are enough for whole of the PDCCH transmission associated with all SS/PBCH blocks, determining, from the available slots, extending slots which are used for the at least one repetition, wherein the extending slots correspond to a repetition pattern which is different from an original pattern corresponding to an occasion for an original transmission of the PDCCH transmission.

In some example embodiments, the multiplexing pattern is a second scheme for multiplexing the SS/PBCH block and a control resource set, the second apparatus further comprises: means for determining the resource for the at least one repetition based on one or more available slots in a first half of the frame and/or in a second half of the frame, wherein the SS/PBCH block is contained in the first half of the frame and/or in the second half of the frame.

In some example embodiments, the repetition factor is associated with at least one of the following: a first factor used for intra-slot repetition, a second factor used for inter-slot repetition within the frame, or a third factor used for inter-slot repetition across frames.

In some example embodiments, the second apparatus further comprises: means for determining the second factor based on the repetition factor and the first factor; or means for determining the third factor based on the repetition factor, the first factor and the second factor.

In some example embodiments, a priority of the first factor is higher than a priority of the second factor, and the priority of the second factor is higher than a priority of the third factor.

In some example embodiments, the first apparatus comprises a terminal device, and the second apparatus comprises a network device.

In some example embodiments, the second apparatus further comprises means for performing other operations in some example embodiments of the method 900 or the second apparatus 120. In some example embodiments, the means comprises at least one processor; and at least one memory storing instructions that, when executed by the at least one processor, cause the performance of the second apparatus.

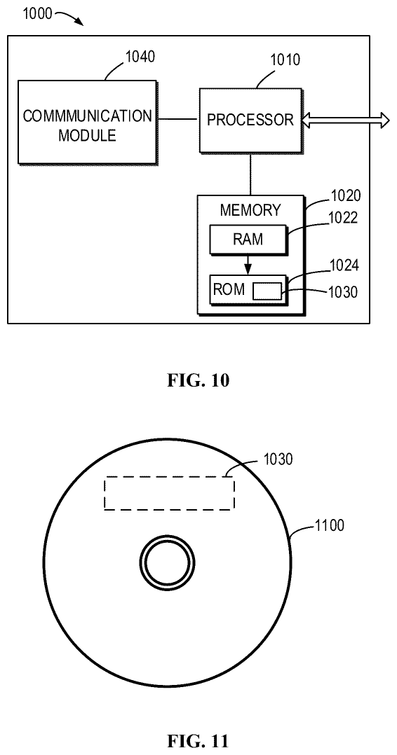

FIG. 10 is a simplified block diagram of a device 1000 that is suitable for implementing example embodiments of the present disclosure. The device 1000 may be provided to implement a communication device, for example, the first apparatus 110 or the second apparatus 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
determine, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and
monitor, on the resource, the at least one repetition of the PDCCH transmission for obtaining control information from a second apparatus.

2. The first apparatus of claim 1, wherein the first apparatus is caused to:
determine the resource for the at least one repetition based on one or more available slots in a first half of the frame, wherein the SS/PBCH block is contained in the first half of the frame.

3. The first apparatus of claim 2, wherein the multiplexing pattern is a first scheme for multiplexing the SS/PBCH block and a control resource set for the PDCCH transmission, and the first apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

4. The first apparatus of claim 2, wherein the multiplexing pattern is a first scheme for multiplexing the SS/PBCH block and a control resource set for the PDCCH transmission, and the first apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein the first apparatus is caused to:
determine the resource based on the following:
$${n}_{0 , j}^{frame} = ( O \cdot {2}^{μ} + ⌊ ( i + j \cdot {L}_{max} ) \cdot M ⌋ ) / {N}_{slot}^{frame , μ}$$
where n_{0,j}^{frame} represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH block indices in a cell, Nₛₗₒₜ^{frame,μ} slot represents the total number of slots in the frame, O represents the offset from the first slot in the frame, and M represents the multiplexing factor.

5. The first apparatus of claim 2, wherein the multiplexing pattern is a first scheme for multiplexing the SS/PBCH block and a control resource set for the PDCCH transmission, and the first apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

6. The first apparatus of claim 2, wherein the multiplexing pattern is a first scheme for multiplexing the SS/PBCH block and a control resource set for the PDCCH transmission, and the first apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

7. The first apparatus of claim 2, wherein the multiplexing pattern is a second scheme for multiplexing the SS/PBCH block and a control resource set for the PDCCH transmission, and the first apparatus is caused to:
in accordance with a determination that the available slots in the first half of the frame are not enough for whole of the PDCCH transmission associated with all SS/PBCH blocks, determine that a part of the SS/PBCH blocks is transmitted with the at least one repetition in the frame and the other part of the SS/PBCH blocks is discarded; or
in accordance with a determination that the available slots in the first half of the frame are not enough for whole of the PDCCH transmission associated with all SS/PBCH blocks, determine that a first part of the SS/PBCH blocks is transmitted with the at least one repetition in the frame and a second part of the SS/PBCH blocks is transmitted with the at least one repetition in a further frame.

8. The first apparatus of claim 2, wherein the multiplexing pattern is a second scheme for multiplexing the SS/PBCH block and a control resource set for the PDCCH transmission, and the first apparatus is caused to:
in accordance with a determination that the available slots in the first half of the frame are not enough for whole of the PDCCH transmission associated with all SS/PBCH blocks, determine that a part of the SS/PBCH blocks is transmitted with the at least one repetition in the frame and the other part of the SS/PBCH blocks is discarded; or
in accordance with a determination that the available slots in the first half of the frame are not enough for whole of the PDCCH transmission associated with all SS/PBCH blocks, determine that a first part of the SS/PBCH blocks is transmitted with the at least one repetition in the frame and a second part of the SS/PBCH blocks is transmitted with the at least one repetition in a further frame, wherein the first part of the SS/PBCH blocks and the second part of the SS/PBCH blocks are transmitted in a round robin way.

9. The first apparatus of claim 2, wherein the multiplexing pattern is a second scheme or a third scheme for multiplexing the SS/PBCH block and a control resource set for the PDCCH transmission, and the first apparatus is caused to:
in accordance with a determination that the available slots in the first half of the frame are enough for whole of the PDCCH transmission associated with all SS/PBCH blocks, determine, from the available slots, extending slots which are used for the at least one repetition, wherein the extending slots correspond to a repetition pattern which is the same as an original pattern corresponding to an occasion for an original transmission of the PDCCH transmission; or
in accordance with a determination that the available slots in the first half of the frame are enough for whole of the PDCCH transmission associated with all SS/PBCH blocks, determine, from the available slots, extending slots which are used for the at least one repetition, wherein the extending slots correspond to a repetition pattern which is different from an original pattern corresponding to an occasion for an original transmission of the PDCCH transmission.

10. The first apparatus of claim 1, wherein the multiplexing pattern is a second scheme for multiplexing the SS/PBCH block and a control resource set, and the first apparatus is caused to:
determine the resource for the at least one repetition based on one or more available slots in a first half of the frame and/or in a second half of the frame, wherein the SS/PBCH block is contained in the first half of the frame and/or in the second half of the frame.

11. The first apparatus of claim 1, wherein the repetition factor is associated with at least one of the following:
a first factor used for intra-slot repetition,
a second factor used for inter-slot repetition within the frame, or
a third factor used for inter-slot repetition across frames.

12. The first apparatus of claim 11, wherein the first apparatus is caused to:
determine the second factor based on the repetition factor and the first factor; or
determine the third factor based on the repetition factor, the first factor and the second factor.

13. The first apparatus of claim 11, wherein a priority of the first factor is higher than a priority of the second factor, and the priority of the second factor is higher than a priority of the third factor.

14. The first apparatus of claim 1, wherein the first apparatus comprises a terminal device, and the second apparatus comprises a network device.

15. A second apparatus comprising:
at least one processor; and
at least one memory storing instructions that, when executed by the at least one processor, cause the second apparatus at least to:
determine, within a frame in which a synchronization signal physical broadcast channel block, SS/PBCH block, is transmitted, a resource for at least one repetition of a physical downlink control channel, PDCCH, transmission based on a repetition factor configured for the PDCCH transmission and a multiplexing pattern associated with the SS/PBCH block and the PDCCH transmission; and
transmit, to a first apparatus, the at least one repetition of the PDCCH transmission on the resource.

16. The second apparatus of claim 15, wherein the second apparatus is caused to:
determine the resource for the at least one repetition based on one or more available slots in a first half of the frame, wherein the SS/PBCH block is contained in the first half of the frame.

17. The second apparatus of claim 16, wherein the multiplexing pattern is a first scheme for multiplexing the SS/PBCH block and a control resource set for the PDCCH transmission, and the second apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set.

18. The second apparatus of claim 16, wherein the multiplexing pattern is a first scheme for multiplexing the SS/PBCH block and a control resource set for the PDCCH transmission, and the second apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein the second apparatus is caused to:
determine the resource based on the following:
$${n}_{0 , j}^{frame} = ( O \cdot {2}^{μ} + ⌊ ( i + j \cdot {L}_{max} ) \cdot M ⌋ ) / {N}_{slot}^{frame , μ}$$
where n_{0,j}^{frame} represents a slot used for the j^{th} repetition in the at least one repetition, j∈{0, 1, . . . , K−1}, K represents a repetition factor used for inter-slot repetition within the frame, μ represents the first parameter, i represents an SS/PBCH block index, Lₘₐₓ represents the maximum number of SS/PBCH blocks indices in a cell, Nₛₗₒₜ^{frame,μ} represents the total number of slots in the frame, O represents the offset from the first slot in the frame, and M represents the multiplexing factor.

19. The second apparatus of claim 16, wherein the multiplexing pattern is a first scheme for multiplexing the SS/PBCH block and a control resource set for the PDCCH transmission, and the second apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein one of the one or more available slots that overlaps with a slot for an original transmission of the PDCCH transmission is discarded from slots to be used for the at least one repetition of the PDCCH transmission, wherein the original transmission is associated with an SS/PBCH block index of the SS/PBCH block.

20. The second apparatus of claim 16, wherein the multiplexing pattern is a first scheme for multiplexing the SS/PBCH block and a control resource set for the PDCCH transmission, and the second apparatus is caused to:
determine the resource for the at least one repetition of the PDCCH transmission in the one or more available slots based on a first parameter associated with subcarrier spacing of the control resource set, a total number of slots in the frame, a maximum number of SS/PBCH blocks indices in a cell, an offset from the first slot in the frame and a multiplexing factor indicating the number of search space sets corresponding to SS/PBCH block indices in a slot, wherein the total number of slots in the frame is determined based on the first parameter associated with subcarrier spacing of the control resource set, wherein if a slot that is used for one of the at least one repetition of the PDCCH transmission overlaps with a slot for an original transmission of the PDCCH transmission, one of the at least one repetition of the PDCCH transmission associated with all SS/PBCH block indices is skipped, wherein the at least one repetition of the PDCCH transmission is associated with an SS/PBCH block index of the SS/PBCH block.

21-33. (canceled)
